(19) United States
(12) Patent Application Publication
(10) Pub. No.: US 2026/0086394 A1
(43) Pub. Date: Mar. 26, 2026

(54) PHOTOCHROMIC OPTICAL ARTICLE HAVING A MIRROR COATING

(71) Applicant: Essilor International, Charenton-le-Pont (FR)

(72) Inventors: Surin MAIDAM, Bangkok (TH); Philippe ROMAND, Charenton-le-Pont (FR)

(21) Appl. No.: 18/859,405

(22) PCT Filed: Apr. 25, 2023
(86) PCT No.: PCT/EP2023/060823

§ 371 Date: Oct. 23, 2024

(30) Foreign Application Priority Data
Apr. 26, 2022 (EP) 22305622.7

(51) Int. Cl. G02C 7/10; G02C 7/14

(52) U.S. Cl. CPC G02C 7/102; G02C 7/14

(57) ABSTRACT

The invention relates to an optical article comprising at least: (a) a substrate having a front main face and with a rear main face: (b) at least one photochromic compound that is able to undergo a transformation from one state, defined as “deactivated state” to another state, defined as “activated state” in response to predetermined wavelengths of the electromagnetic spectrum, (c) coated directly or indirectly onto the front face of said substrate (a), a mirror coating, said mirror coating—comprising at least two layers having a low refractive index which is lower than 1.55, defined as “LI layer”, and at least two layers having a high refractive index which is equal to or higher than 1.55, defined as “HI layer”,—and having a mean light reflection factor for wavelengths ranging into said predetermined wavelengths of the electromagnetic spectrum, defined as Rm_{(predetermined spectrum)} that is lower than or equal to 1.0%, for an angle of incidence of 15°; a mean light reflection factor in the visible region Rᵥ that is lower than or equal to 10.0% for an angle of incidence of 15°; and an optical robustness corresponding to the standard deviation of said mean light reflection factor in the visible region Rᵥ, defined as “σRᵥ” that is lower than or equal to 0.7% for an angle of incidence of 15°.

### TECHNICAL FIELD OF THE INVENTION

The invention relates to a photochromic optical article comprising a substrate coated with a mirror coating having improved global performances (photochromic, durability and mechanically, etc.). The optical article may especially be an ophthalmic lens, in particular a spectacle lens, such as sunglass lenses.

### BACKGROUND INFORMATION AND PRIOR ART

The phenomenon of photochromism has been known for many years. A compound is described as photochromic when, for example, this compound, irradiated with a light beam containing some wavelengths in the ultraviolet region, changes colour and returns to its original colour when the irradiation ceases.

In particular, photochromic compounds undergo a transformation from one state (or form) to another state in response to certain wavelengths of electromagnetic radiation (i.e., “actinic radiation”). Each state has a characteristic absorption spectrum. For example, many photochromic compounds transform from a deactivated (e.g., bleached or substantially colorless) state to an activated (e.g., tinted) state upon exposure to actinic radiation. When the actinic radiation is removed, the photochromic compounds reversibly transform from the activated state back to the deactivated state.

There are many applications of this phenomenon, but one of the most useful known applications is in the ophthalmic optics field, in the manufacture of photochromic lenses or spectacle glasses, so as to filter the light radiation as a function of its intensity.

Especially, photochromic lenses are able to exhibit a reversible change in transmission when exposed to a light radiation involving ultraviolet rays, such as the ultraviolet radiation in sunlight or the light of a mercury lamp. Indeed, when they absorb specific wavelengths in the UV region, the photochromic compounds contained in the photochromic lens change their states and consequently cause the lens to darken.

Hence, photochromic lenses adapt their transmission to the variable light intensity while keeping the brightness on the eyes sufficiently constant. This may be for instance useful when a big change of luminous intensity take place, for example, when getting out of the car and into the sunshine, or during open air activities such as activities on high mountains and at seaside resorts.

Some photochromic lenses have been proposed in the prior art.

For instance, the document US 2004/0240067 describes a multi-layer thin film coating for use with photochromic lenses, said multi-layer thin film comprising a plurality of dielectric layers selected and arranged so as to reflect an amount less than about 15%, preferably less than 6% of spectral UVA radiation in a range between 315 and 400 nm, preferably from 350 to 380 nm.

In particular, this document describes a multi-layer thin film that may be a mirror coating that would have either low or preferably no inhibition of photochromic activation. This mirror coating comprises at least 12 alternated layers having a low refractive index and a high refractive index and has an average reflectance lower than 10%, but higher than 5% for wavelength ranges from 350 to 380 nm (FIG. 4).

However, the mirror coating described in this document does not have satisfying optical-quality performances, especially in terms of reflectance in the UV range (i.e.: 350-380 nm) especially when the photochromic lens comprises a mirror coating and in terms of color and optical robustness.

Hence, an object of the present invention is thus to propose a new optical article which avoids, at least in part, the aforementioned drawbacks.

In particular, an object of the present invention is also to provide a novel multilayered interferential coating, especially a novel mirror coating, that has improved abrasion resistance properties, such as mechanical crazing properties, and improved thermal crazing properties.

### SUMMARY OF THE INVENTION

The Applicant sought to develop a new photochromic optical article having improved optical-quality mirror coating, especially for the ophthalmic field. Indeed, a photochromatic lens comprising a mirror coating is harder to design as compared for instance to a full tint lens comprising a mirror.

For that purpose, the Applicant discovered design rules for optimizing the global performances (mechanical, durability, photochromatic, etc.) of photochromatic lenses comprising a mirror coating.

In particular, the Applicant discovered that a photochromatic lens that fulfills preferably some specific requirements/conditions enables to improve its optimal optical-quality performances.

Especially, these conditions for photochromic lenses found by the Applicant are as follows:
to optimize the antireflective properties in the visible region in order to keep a high transmission when the photochromatic lens is an unactuated state;
to optimize the reflection in a predetermined wavelength band of the electromagnetic spectrum, that is to say in the wavelengths band where the photochromic compounds are activated for darken the lens (i.e.: hence, the mirror coating does not interfere with the photochromic compound action during the activated state); and
to optimize both the color robustness and the optical robustness of the chromatic optical article.

However, designing such photochromic lenses comprising a mirror coating that fulfill these above-mentioned requirements comprises many technical challenges.

The invention relates therefore to an optical article comprising at least:
(a) a substrate having a front main face and with a rear main face;
(b) at least one photochromic compound that is able to undergo a transformation from one state, defined as “deactivated state” to another state, defined as “activated state” in response to predetermined wavelengths of the electromagnetic spectrum,
(c) coated directly or indirectly onto the front face of said substrate (a), a mirror coating, said mirror coating
   comprising at least two layers having a low refractive index which is lower than 1.55, defined as “LI layer”, and at least two layers having a high refractive index which is equal to or higher than 1.55, defined as “HI layer”,
   and having
   a mean light reflection factor for wavelengths ranging into said predetermined wavelengths of the electromagnetic spectrum, defined as Rm_{(predetermined spectrum)} that is lower than or equal to 1.0%, for an angle of incidence of 15°;
   a mean light reflection factor in the visible region Rᵥ that is lower than or equal to 10.0% for an angle of incidence of 15° and especially that is higher than 2.3%, preferably higher than 2.5%; and
   an optical robustness corresponding to the standard deviation of said mean light reflection factor in the visible region Rᵥ, defined as “σRᵥ” that is lower than or equal to 0.7% for an angle of incidence of 15°.

In general, the predetermined wavelengths of the electromagnetic spectrum ranges from 360 nm to 420 nm.

Indeed, thanks to its characteristics, the mirror coating according to the invention allows to provide both a low reflection in the visible region ranges from 380 nm to 780 nm so as to avoid reflection from the front face of the optical article and a very low reflection at predetermined wavelengths band corresponding to the activation zone of the at least one photochromatic compound, corresponding preferably to wavelengths ranging from 360 nm to 420 nm.

The mirror coating according to the invention also allows to provide an excellent optical and color robustness as it will be shown in the experimental assays described below.

In addition, the mirror coating according to the invention has a good abrasion resistance as well as a good heat and temperature variations resistance. For some of the exemplified lenses, the abrasion and/or scratch resistance is very good and the critical temperature at 1 month is improved.

### BRIEF DESCRIPTION OF THE DRAWINGS

For a more complete understanding of the description provided herein and the advantages thereof, reference is now made to the brief descriptions below, taken in connection with the accompanying drawings and detailed description.

FIG. 1 shows the variation of the refection (R, %) on the front surface of the mirror coating of the exemplified lenses 1 to 4 according to the invention prepared in the examples 1 to 4, respectively, for the spectral function W(λ) at an angle of incidence of 15° as function of the wavelength in the visible region (360-780 nm);

FIG. 2 shows the variation of the refection (R, %) on the front surface of the mirror coating of the exemplified lenses 5 to 8 according to the invention prepared in the examples 5 to 8, respectively, for the spectral function W(λ) at an angle of incidence of 15° as function of the wavelength in the visible region (360-780 nm);

FIG. 3 shows the variation of the refection (R, %) on the front surface of the mirror coating of the exemplified lenses 9 to 11 according to the invention prepared in the examples 9 to 11, respectively, for the spectral function W(λ) at an angle of incidence of 15° as function of the wavelength in the visible region (360-780 nm); and

FIG. 4 shows the variation of the refection (R, %) on the front surface of the mirror coating of the exemplified lenses 12 to 15 according to the invention prepared in the examples 12 to 15, respectively, for the spectral function W(λ) at an angle of incidence of 15° as function of the wavelength in the visible region (360-780 nm).

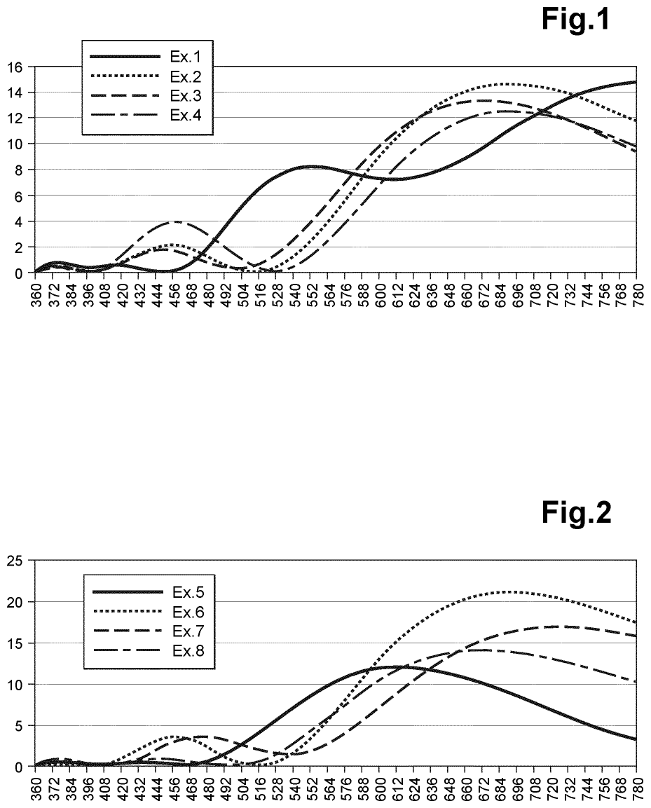

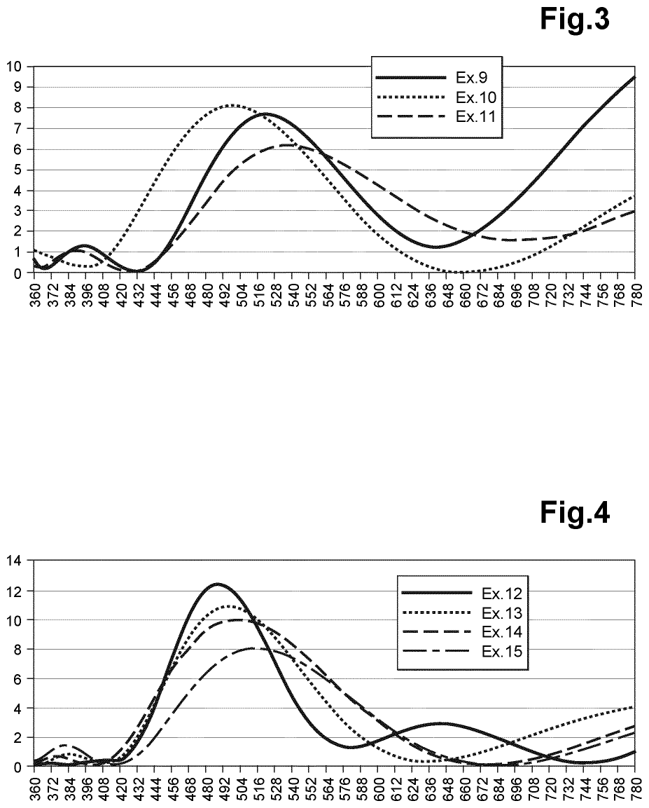

### DETAILED DESCRIPTION OF THE INVENTION

### A) Definitions

The terms “comprise” (and any grammatical variation thereof, such as “comprises” and “comprising”), “have” (and any grammatical variation thereof, such as “has” and “having”), “contain” (and any grammatical variation thereof, such as “contains” and “containing”), and “include” (and any grammatical variation thereof, such as “includes” and “including”) are open-ended linking verbs. They are used to specify the presence of stated features, integers, steps or components or groups thereof, but do not preclude the presence or addition of one or more other features, integers, steps or components or groups thereof. As a result, a method, or a step in a method, that “comprises,” “has,” “contains,” or “includes” one or more steps or elements possesses those one or more steps or elements, but is not limited to possessing only those one or more steps or elements.

Unless otherwise indicated, all numbers or expressions referring to quantities of ingredients, ranges, reaction conditions, etc. used herein are to be understood as modified in all instances by the term “about.”

Also, unless otherwise indicated, the indication of an interval of values «from X to Y» or “between X to Y”, according to the present invention, means as including the values of X and Y.

As used herein, by “photochromic lens”, we mean an ophthalmic article defined by, but not exclusive of corrective lenses, non-corrective lenses, contact lenses, intra-ocular lenses, magnifying lenses, protective lenses, and visors containing photochromic compounds within a coating, the lens material, a film, or any adjacent layer.

In the present application, when an optical lens comprises one or more coatings onto the surface thereof, the expression “to deposit a layer or a coating onto the article” is intended to mean that a layer or a coating is deposited onto the external (exposed) surface of the outer coating of the article, that is to say its coating that is the most distant from the substrate.

Unless otherwise indicated, a coating, that is said to be “on” a substrate or deposited “onto” a substrate is defined as a coating, which (i) is positioned above the substrate, (ii) is not necessarily in contact with the substrate, that is to say one or more intermediate coatings may be arranged between the substrate and the coating in question, and (iii) does not necessarily completely cover the substrate.

In a preferred embodiment, the coating on a substrate or deposited onto a substrate is in direct contact with this substrate.

When “a layer 1 is lying under a layer 2”, it is intended to mean that layer 2 is more distant from the substrate than layer 1.

According to the embodiments described hereafter, the multilayered interferential coating is preferably a mirror coating. Hence, for the rest of the description, these two terms are similar.

A mirror is a coating, deposited on the surface of an article, which reflects at least a part of light arriving on said surface. Said mirror increases light reflection at the article/air interface over a determined portion of the spectrum. Reflection may be in the ultraviolet spectrum or in the visible spectrum or in the infrared spectrum.

By outermost layer of the mirror coating, it is meant the layer of the mirror coating (MC) coating which is the furthest from the substrate.

By innermost layer of the mirror coating, it is meant the layer of the mirror coating which is the closest to the substrate.

By inner layer of the mirror coating, it is meant any layer of the mirror coating except for the outermost layer of said mirror coating.

Also, unless stated otherwise, all thicknesses disclosed in the present application relate to physical thicknesses.

As used herein, a layer of the mirror coating is defined as having a thickness higher than or equal to 1 nm. Thus, any layer having a thickness lower than 1 nm will not be considered when counting the number of layers in the mirror coating. A sub-layer is also not considered when counting the number of layers of the mirror coating.

According to the invention and unless stated otherwise, all thicknesses disclosed in the present application relate to physical thicknesses.

Unless otherwise specified, the refractive indexes referred to in the present application are expressed at 25° C. at a wavelength of 550 nm.

As used herein, the rear (or the inner or Concave or CC) face of the substrate is intended to mean the face which, when using the article, is the nearest from the wearer's eye. It is generally a concave face. On the contrary, the front face of the substrate (or Convex or CX), is the face which, when using the article, is the most distant from the wearer's eye. It is generally a convex face.

The mirror coating according to the invention may be formed on at least one of the main faces of a bare substrate, i.e., an uncoated substrate, and preferably on the front main face of the substrate already coated with one or more functional coatings, such as an anti-abrasion coating.

Also, as used herein, a “transparent substrate” is understood to be transparent, when the observation of an image through said substrate is perceived with no significant loss of contrast, that is, when the formation of an image through said substrate is obtained without adversely affecting the quality of the image.

The term cosmetic appearance means that there is no, or almost no, cosmetic defects over time evaluated visually in transmission and is preferably measured under an arc lamp.

The colorimetric coefficients of the optical article of the invention in the international colorimetric system CIE L*a*b* (1976) (such as the Chroma C* and the hue “h”) are calculated between 380 and 780 nm, taking the standard illuminant D 65 and the observer into account (angle of) 10°. The observer is a “standard observer” as defined in the international colorimetric system CIE L*a*b*. Indeed, in the CIE L*a*b* space, it is possible to express not only overall variations in color, but also in relation to one or more of the parameters L*, a* and b*. This can be used to define new parameters and to relate them to the attributes of the visual sensation. Clarity, related to luminosity, is directly represented by the value of L*. Chroma: C*=(a⁺²+b²)^{1/2} defines the chromaticness. The angle of hue: h=tg−1 (b*/a*) (expressed in degrees); related to hue.

According to the invention, the colorimetric measurements (in reflection) of the face coated with the mirror coating of the invention (convex/front face): reflection factors Rv, Rm _{(predetermined wavelength)} or Rm ₍₃₆₀₋₄₂₀₎, hue angle h, a*, b* and chroma C* in the international colorimetric CIE (L*, a*, b*) space were carried out with a Zeiss spectrophotometer, taking into account the standard illuminant D65, and the standard observer 10° (for h and C*). They are provided for an angle of incidence of 15°.

According to the invention, the “angle of incidence (symbol 0)” is the angle formed by a ray light incident on an ophthalmic lens surface and a normal to the surface at the point of incidence. The ray light is for instance an illuminant light source, such as the standard illuminant D65 as defined in the international colorimetric CIE L*a*b* (1976). Generally, the angle of incidence changes from 0° (normal incidence) to 90° (grazing incidence). The usual range for angle of incidence is from 0° to 75° and is typically 15° for the present invention.

The term “robustness” of an optical article, such as an ophthalmic lens, in the present invention is defined as the ability of this lens to resist change despite the variations induced by its manufacture process. These variations depend, for instance, on the type of substrate which is used, the setting of the manufacturing machine (temperature schedule, appropriate time, setting of the electron gun . . . ) and/or its usage mode, the replacement of said manufacturing machine by another one.

Indeed, when an interferential multilayered coating, such as a mirror coating, is manufactured at industrial scale, some thickness variations for each layer generally occur. These variations lead to different reflection performance, and especially different perceived residual reflected color of the interferential multilayered coating. If the perceived residual reflected color of the interferential coating of two lenses is different, these lenses will appear different and will not be able to be associated in pair.

According to the invention, the robustness of various parameters was calculated with the Essential Mac Leod software provided by Thin Film Center. A simulation was made so as to test the robustness (also called standard deviation or Std Dev) of the mirror coating according to the invention. 500 iterations were made so as to evaluate the impact of the thickness variations (one standard deviation corresponds to +2.2% variation in normal/gaussian distribution for the thickness of each layer of the stack, all varied independently and at the same time) induced by the manufacturing process which may affect the performances and properties of two different lens comprising the same structure (same composition and thickness layers), such as chroma C* (in reflection) and the optical factors: Rᵥ, Rₘ for an angle of incidence of 15° (illuminant D65 and observer) 10°. The “average” values given below are the average values of the parameters on 500 samples obtained after applying a ±2.2% random variation to the thickness of each layer of the stack. The standard deviation quantifies the amount of variation or dispersion of the set of data values. A low standard deviation indicates that the data points tend to be close to the average of the parameter.

Herein, the “luminous reflectance” noted Rᵥ, is such as defined in the ISO 13666:1998 Standard, and measured in accordance with the ISO 8980-4, i.e. this is the weighted spectral reflection average over the whole visible spectrum between 380 and 780 nm. Rᵥ is usually measured for an angle of incidence lower than 17°, typically of 15°, but can be evaluated for any angle of incidence.

In the present application, the “mean reflection factor,” noted R_{m (X-Y)}, is such as defined in the ISO 13666:1998 Standard, and measured in accordance with the ISO 8980-4 Standard, i.e. this is the (non weighted) spectral reflection average over the electromagnetic spectrum between the wavelength “X” and “Y” nm. According the the invention, Rₘ is measured for different angle of incidence.

For instance, the characteristic mean reflection factor for wavelengths ranging from 360 nm to 420 nm, noted Rm ₍₃₆₀₋₄₂₀₎ is defined by the formula and assuming a measurement step of 1 nm:

$${R}_{m ( 360 - 420 )} = \frac{{\int }_{360}^{420} R ( λ ) d λ}{420 - 360}$$

wherein R(λ) represents the reflection factor at wavelength λ.

R_{m (360-420)} can be measured for any angle of incidence 0, based on R(λ) measured at the same angle of incidence.

### B) Optical Article According to the Invention

As mentioned-above, the Applicant has developed a transparent optical article, especially an ophthalmic lens such as spectacle lens, comprising a substrate in mineral or organic glass comprising at least a mirror coating (MC), said mirror coating possessing both a low reflection in the visible region especially when the photochromic compound is in an deactivated state, and a very low reflection in a predetermined wavelength band corresponding to the wavelength band where the photochromic compounds may be activated and to do so without compromising not only the optical and color robustness of the optical article, its cosmetic appearance, but also the economic and/or industrial feasibility of its manufacture.

The optical article is such as defined in the set of claims and comprises at least a substrate having a front main face and with a rear main face, at least one photochromatic compound and coated directly or indirectly onto the front face of said substrate, a mirror coating.

### B.1 the Substrate

The optical article according to the present invention comprises a transparent optical article, preferably a lens or lens blank, and more preferably an ophthalmic lens or lens blank.

Generally speaking, the interferential multilayered coating of the optical article according to the invention, which may be an antireflective coating (called hereafter AR coating), may be deposited onto any substrate, and preferably onto organic lens substrates, for example a thermoplastic or thermosetting plastic material.

Thermoplastic may be selected from, for instance: polyamides; polyimide; polysulfones; polycarbonates and copolymers thereof; poly(ethylene terephthalate) and polymethylmethacrylate (PMMA).

Thermoset materials may be selected from, for instance: cycloolefin copolymers such as ethylene/norbornene or ethylene/cyclopentadiene copolymers; homo- and copolymers of allyl carbonates of linear or branched aliphatic or aromatic polyols, such as homopolymers of diethylene glycol bis(allyl carbonate) (CR 39®); homo- and copolymers of (meth)acrylic acid and esters thereof, which may be derived from bisphenol A; polymer and copolymer of thio(meth)acrylic acid and esters thereof, polymer and copolymer of allyl esters which may be derived from Bisphenol A or phthalic acids and allyl aromatics such as styrene, polymer and copolymer of urethane and thiourethane, polymer and copolymer of epoxy, and polymer and copolymer of sulphide, disulfide and episulfide, and combinations thereof.

As used herein, a (co)polymer is intended to mean a copolymer or a polymer. As used herein, a (meth)acrylate is intended to mean an acrylate or a methacrylate. As used herein, a polycarbonate (PC) is intended to mean either homopolycarbonates or copolycarbonates and block copolycarbonates.

Homopolymers of diethylene glycol bis(allyl carbonate) (CR 39@), allylic and (meth)acrylic copolymers, having a refractive index between 1,54 and 1,58, polymer and copolymer of thiourethane, polycarbonates are preferred.

The substrate may be coated with one or more functional coatings prior to depositing the antireflective coating of the invention. These functional coatings traditionally used in optics may be, without limitation, an impact-resistant primer layer, an abrasion-resistant coating and/or a scratch-resistant coating, a polarizing coating, a photochromic coating or a tinted coating. In the following a substrate means either a bare substrate or such a coated substrate.

Preferably, the substrate and the optional abrasion-resistant coating and/or a scratch-resistant coating generally coated onto said substrate have a similar/close refractive index so as to avoid fringes or cosmetic defects.

Prior to depositing the antireflective coating, the surface of said substrate is usually submitted to a physical or chemical surface activating treatment, so as to reinforce the adhesion of the antireflective coating. Such pre-treatment is generally conducted under vacuum. It may be a bombardment with energetic and/or reactive species, for example with an ion beam (“Ion Pre-Cleaning” or “IPC”) or with an electron beam, a corona discharge treatment, an ion spallation treatment, an ultraviolet treatment or a plasma-mediated treatment under vacuum, generally using an oxygen or an argon plasma. It may also be an acid or basic treatment and/or a solvent-based treatment (water, hydrogen peroxide or any organic solvent).

### B.2 the Photochromatic Compounds

As mentioned above, the photochromatic compounds of the invention are able to undergo a transformation from one state, defined as “deactivated state” to another state, defined as “activated state” in response to predetermined wavelengths of the electromagnetic spectrum, preferably ranges from 360 nm to 420 nm.

Hence, the photochromic compounds suitable for the present invention are compounds having at least one wavelength in the range from 360 to 420 nm characterized by a maximum absorption when excited by a light beam.

The photochromic compounds, which may be incorporated in the inventive curable coating composition, may be, without limitation, oxazine derivatives, for example spirooxazines, chromenes, photochromic derivatives of chromene such as pyranes, especially spiropyranes, fulgides, fulgimides, organometallic derivatives of dithizonate, and and combinations of any of the aforementioned photochromic compounds.

Compounds comprising an oxazine group, in particular spirooxazines, are photochromic compounds that are well known in the art. They are described, among others, in the following documents: U.S. Pat. Nos. 4,562,172, 3,578,602, 4,215,010, 4,720,547, 5,139,707, 5,114,621, 5,529,725, 5,645,767, 5,658,501, WO 87/00524, WO 96/04590, JP 03251587, FR 2647789, FR 2647790, FR 2763070, EP 0245020 and EP 0783483. For instance, they may correspond to benzoxazines, naphthoxazines, and spirooxazines. The preferred oxazine compounds are spiro[indolino] benzoxazines, spiro[indolino] naphtoxazines and spiro[indolino] pyridobenzoxazines.

Chromenes and photochromic compounds of chromene are also well known and are described, among others, in the following documents: EP 0246114, EP 0401958, EP 0562915, EP 0629656, EP 0676401, FR 2688782, FR 2718447, WO 90/07507, WO91/06861, WO 93/17071, WO 94/20869, U.S. Pat. Nos. 3,567,605, 5,066,818, 5,395,567, 5,451,344, 5,645,767, 5,656,206 and 5,658,501. The preferred chromenes and photochromic compounds of chromene may correspond to pyranes, especially spiropyranes benzopyrans, naphthopyrans (for example naphtho[1,2-b]pyrans and naphtho[2,1-b]pyrans)spiro-9-fluoreno [1,2-b]pyrans, phenanthropyrans, quinopyrans, and indeno-fused naphthopyrans, such as those disclosed in U.S. Pat. No. 5,645,767 at column 1, line 10 to column 12, line 57 and in U.S. Pat. No. 5,658,501 at column 1, line 64 to column 13, line 36. Among those compounds, a preferred compound is selected from naphtopyranes, in particular, those bearing two optionally substituted phenyl groups on the carbon adjacent to the oxygen atom of the pyran ring. In addition, among those compounds, another preferred compound is selected from spiropyranes.

Photochromic fulgides and fulgimides compounds are known compounds and are described, among others, in patents U.S. Pat. No. 4,931,220 and EP 0629656 and may include for example 3-furyl and 3-thienyl fulgides and fulgimides, which are described in U.S. Pat. No. 4,931,220 at column 20, line 5 through column 21, line 38; diarylethenes, which are described in U.S. Patent Application Publication No. 2003/0174560 from paragraph to [0086].

For example, the at least photochromic compound according to the invention can comprise a compound selected from the group consisting of naphthopyrans, benzopyrans, phenanthropyrans, indenonaphthopyrans, spiro(indoline) naphthoxazines, spiro(indoline)pyridobenzoxazines, spiro(benzindoline)pyridobenzoxazines, spiro(benzindoline) naphthoxazines, spiro(indoline)benzoxazines, fulgides, fulgimides, and mixtures thereof.

In general, the at least one photochromic compound is incorporated directly into the substrate, and/or is incorporated in one coating deposited directly or indirectly at the surface of the substrate, so as to form a photochromic substrate.

The method for incorporating directly the at least photochromic compound into the substrate is well known for the skilled person and will be summarized as follows.

For instance, a first used method is the method known as “thermal transfer” (imbibition), in which the organic photochromic compounds, such as spirooxazines or chromenes, are applied to the lens substrate by means of a temporary support such as a varnish, then the coated lens substrate is heated so as to cause the transfer of the photochromic compound of the varnish onto the main face of the lens. This method is especially disclosed in patents U.S. Pat. Nos. 4,286,957 and 4,880,667.

A second technique known as “cast-in-place” consists of incorporating the photochromic organic compounds into a polymerizable mixture leading to a transparent organic material, introducing this into a mould and then initiating its polymerization. After removal from the mould, a photochromic ophthalmic lens is obtained, the photochromic molecules of which are incorporated into the bulk of this lens.

However, some organic materials used in ophthalmic optics such as polycarbonates (thermoplastic materials generally transformed by injection moulding) have a polymer matrix which is unsuitable for being imbibed by photochromic compounds.

In that case, it is preferable to incorporate the at least photochromic compound into one coating deposited directly or indirectly at the surface of the substrate. In particular, this method consists in applying to the surface of a preformed ophthalmic lens a coating composition containing dissolved photochromic compounds capable to form a material that can host photochromic compounds. The nature of the material constituting the ophthalmic lens onto which the photochromic coating is applied is thus, in principle, no longer relevant. Such a technique is disclosed for example in the patent EP 146136. The curable coating composition described in the document WO 2008/031879 incorporating at least one photochromatic compound may be also suitable for the present invention.

In general, the photochromic compound enables to colour the substrate in its activated state, preferably in a tint selected from grey or brown.

For instance, the substrate incorporating at least one photochromatic compound may be selected from the products commercialized under the tradename: Orma® XA2 Grey, Orma@ XA2 (supplied by Transitions), MR8@-Brow, MR-8@-Grey (supplied by Transitions).

### B.3 Mirror Coating

As previously mentioned, the mirror coating according to the invention enables to improve the global performances of the photochromic optical article according to the invention.

In particular, the mirror coating according to the invention has been designed to provide not only a low reflection in approximately the UV band, especially between 360 nm to 420 nm and in the visible region, but also an excellent optical and color robustness, while having a cosmetic appearance.

For these purposes, the mirror coating according to the invention is characterized by various optical parameters that enable to achieve this goal.

First, the mirror coating has a low reflection in the visible region ranging from 380 nm to 780 nm at an angle of incidence of 15°. In particular, the mirror coating has a mean light reflection factor in the visible region Rᵥ that is lower than or equal to 10.0%, preferably lower than or equal to 9.0% for an angle of incidence of 15°. In addition, the mirror coating maty have a mean light reflection factor in the visible region Rᵥ that is higher than 2.3%, preferably higher than 2.5%.

According to the invention, a mean light reflection factor in the visible region Rᵥ that is “lower than or equal to 10.0%” includes the following values and/or any intervals comprised between these values (limits included): 10.0%; 9.5%; 9.0%; 8.5%; 8.0%; 7.5%; 7.0%; 6.5%; 6.0%; 5.5%; 5.0%; 4.5%; 4.0%; 3.5%; 3.0%; 2.5%; 2.4%; 2.3%; etc.

Then, the mirror coating has a mean light reflection factor for wavelengths ranging into the predetermined wavelengths of the electromagnetic spectrum defined for the photochromatic compound, named hereafter Rm _{(predetermined spectrum)}, that is lower than or equal to 1.0%, for an angle of incidence of 15°. In general, Rm_{(predetermined spectrum)} is lower than or equal to 0.9%, preferably 0.8% for an angle of incidence of 15°.

As used herein, a mean light reflection factor Rm _{(predetermined spectrum)}, that is “lower than or equal to 1.0% for an angle of incidence of 15°” includes the following values and/or any intervals comprised between these values (limits included): 1.0%; 0.95%; 0.90%; 0.85%; 0.80%; 0.75%; 0.70%; 0.65%; 0.60%; 0.55%; etc.

Generally, the predetermined wavelengths of the electromagnetic spectrum ranges from 360 nm to 420 nm.

In addition, the mirror coating according to the invention has an excellent optical robustness.

Especially, the mirror coating has a standard deviation of the mean light reflection factor in the visible region Rᵥ, defined as “σR” that is very low and is lower than or equal to 0.7% for an angle of incidence of 15°.

According to the invention, a standard deviation of the mean light reflection factor in the visible region, defined as “σRᵥ” that is “lower than or equal to 0.7%” for an angle of incidence of 15° includes the following values and/or any intervals comprised between these values (limits included): 0.7%; 0.69%; 0.68%; 0.67%; 0.66%; 0.65%; 0.64%; 0.63%; 0.62%; 0.61%; 0.60%; 0.59%; 0.58%; 0.57%; 0.56%; 0.55%; 0.54%; 0.53%; 0.52%; 0.51%; 0.51%; 0.49%; 0.48%; 0.47%; 0.46%; 0.45%; 0.44%; 0.43%; 0.42%; 0.41%; 0.40%; 0.39%; 0.38%; 0.37%; 0.36%; etc.

In particular, the σRᵥ of the mirror coating is lower than or equal to 0.65%, preferebaly lower than or equal to 0.60% for an angle of incidence of 15°.

Moreover, the mirror coating according to the invention has also an excellent color robustness. Indeed, the mirror coating according to the invention has the standard deviation of the Chroma C* and the standard deviation for the hue “h” that are very low. This means that the mirror coating has a great ability to resist change despite the variations induced by its manufacture process. As mentioned above, the hue and the Chroma C* are defined in the international colorimetric CIE L*ab (1976).

Especially, the mirror coating has a hue angle whose standard deviation, defined as “oh”, for an angle of incidence of 15°, is lower than or equal to 13°, preferably lower than or equal to 9°, in particular lower than or equal to 8° and typically lower than or equal to 7°.

As used herein, as standard deviation σh that is “lower than or equal to 13” for an angle of incidence of 15° includes the following values and/or any intervals comprised between these values (limits included): 13°; 12.5°; 12.0°; 11.5°; 11.0°; 10.5°; 10.0°; 9.5°; 9.0°; 8.5°; 8.0°; 7.5°; 7.0°; 6.5°; 6.0°; 5.5°; 5.0°; 4.5°; 4.0°; 3.5°; 3.0°; etc.

It is possible to prepare mirror coatings without limitation as regards their hue angle h (0° to) 360°, which relates to the residual color displayed by said mirror coating in the activated state

In some embodiments, the optical article has a hue angle (h) in the activated state ranging from 50° to 120°, preferably from 25° to 110°, thus resulting in a perceived residual reflected that is brown.

In another embodiment, the optical article has a hue angle (h) higher than or equal to 120°, more preferably higher than or equal to 130° and better ranging from 130° to 200°, thus resulting in a mirror coating having a grey reflection.

In another embodiment, the residual reflected color of the mirror coating is in correlation with the tint of the photochromic substrate in the activated state, in other words, the residual reflected color of the mirror coating falls in the same hue angle range (hue difference≤15%, preferably ≤10% and typically ≤8%) or falls in a similar hue angle range as the one of the photochromic substrate in the activated state. For the determination of this color matching, the parameters of L and C* (international colorimetric CIE L*a*b*) can be used for color comparison between the residual reflected color of the mirror coating and the tint of the photochromic substrate in the activated state.

Hence, preferably, the residual reflected color of the mirror coating does not interfere with the color/tint of the photochromic substrate in the deactivated and/or activated state, especially in the activated state (i.e.: good color matching between the photochromic substrate and the residual reflected color of the mirror coating that minimize the color change during especially the activated state and reduce the impact of transmission color with mirror).

Moreover, the mirror coating has a Chroma C* whose standard deviation, defined as “σC*”, for an angle of incidence of 15° is lower than or equal to 5, preferably lower than or equal to 4, in particular lower than or equal to 3.5 and typically lower than or equal to 3.0.

According to the invention, a standard deviation σC “lower than or equal to 5” for an angle of incidence of 15° includes the following values and/or any intervals comprised between these values (limits included): 5; 4.9; 4.8; 4.7; 4.6; 4.5; 4.4; 4.3; 4.2; 4.1; 4.0; 3.9; 3.8; 3.7; 3.6; 3.5; 3.4; 3.3; 3.2; 3.1; 3.0; 2.9; 2.8; 2.7; 2.6; 2.5; 2.4; 2.3; 2.2; 2.1; 2.0; 1.9; 1.8; 1.7; 1.6; 1.5; 1.4; 1.3; 1.2; 1.1; 1.0; 0.9; 0.8; 0.7; 0.6; 0.5; 0.4; etc.

According to a characteristic of the invention, the mirror coating has a high Chroma C* especially instead of a high visual reflection. In general, the mirror coating has a Chroma C* that is equal to or higher than 20, preferably equal to or higher than 25, in particular equal to or higher than 30.

Different structures of the mirror coating according to the invention will be described hereafter.

The mirror coating of the invention comprises a stack of at least four layers made of dielectric materials having a high refractive index and a low refractive index.

Especially, the mirror coating according to the invention comprises especially at least two layers having a low refractive index which is lower than 1.55, defined as “LI layer”, and at least two layers having a high refractive index which is equal to or higher than 1.55, defined as “HI layer”. It is here a simple stack, since the layer total number in the mirror coating is higher than or equal to 4 and in general lower than or equal to 14.

Indeed, according to a characteristic of the invention, the total number of HI and LI layers in the mirror coating is higher than or equal to 4, preferably higher than or equal to 6.

According to another characteristic of the invention, the total number of alternating HI and LI layers in the antireflective coating is lower than or equal to 12, preferably lower than or equal to 10, in particular lower than or equal to 9 and typically lower than or equal to 8.

HI layers and LI layers don't need to alternate with each other in the stack, although they also may, according to one embodiment of the invention. Two HI layers (or more) may be deposited onto each other, as well as two LI layers (or more) may be deposited onto each other.

In the present application, when two HI layers (or more) are deposited onto each other, they are not considered as being a single HI layer when counting the number of layers of the reflective stack. The same applies to stacks of two or more adjacent LI layers.

In general, the HI layers and LI layers alternate with each other in the stack of the mirror coating according to the invention.

Advantageously, the mirror coating comprises alternately HI layers and LI layers and has a number of layers higher than or equal to 6, preferably higher than or equal to 7 and especially higher than or equal to 8.

In the present application, a layer of the mirror coating is said to be a layer with a high refractive index (HI) when its refractive index is higher than 1.55, preferably higher than or equal to 1.6, even more preferably higher than or equal to 1.8 or 1.9 and most preferably higher than or equal to 2. Said HI layers preferably have a refractive index lower than or equal to 2.2 or 2.1. A layer of the mirror coating is said to be a low refractive index layer (LI) when its refractive index is lower than or equal to 1.55, preferably lower than or equal to 1.52, more preferably lower than or equal to 1.48 or 1.47. Said LI layer preferably has a refractive index higher than or equal to 1.1, more preferably higher than or equal to 1.3 or 1.35.

As is well known, mirror coatings traditionally comprise a multilayered stack composed of dielectric materials (generally one or more metal oxides) and/or sol-gel materials and/or organic/inorganic layers such as disclosed in WO 2013/098531.

The HI layer generally comprises one or more metal oxides such as, without limitation, zirconia (ZrO₂), ZrOₓ with x<2, titanium dioxide (TiO₂), a substoichiometric titanium oxide such as Ti₃O₅, alumina (Al₂O₃), tantalum pentoxide (Ta₂O₅), neodymium oxide (Nd₂O₅), praseodymium oxide (PR₂O₃), praseodymium titanate (PrTiO₃), La₂O₃, Nb₂Os, Y₂O₃, preferably ZrO₂ and Ta₂Os. In some aspects of the invention, the outermost high refractive index layer(s) of the mirror coating do(es) not comprise titanium oxide. In a preferred embodiment, the mirror coating does not comprise any layer comprising TiO₂, or more generally, titanium oxide. As used herein, titanium oxide is intended to mean titanium dioxide or a substoichiometric titanium oxide (TiOₓ, where x<2). Titanium oxide-containing layers are indeed sensitive to photo-degradation.

Optionally, the HI layers may further contain silica or other materials with a low refractive index, provided they have a refractive index higher than 1.55 as indicated hereabove. The preferred materials include TiO₂, Ti₃O₅, ZrO₂ or ZrOₓ with x<2 and mixtures thereof.

In one embodiment, the mirror coating has at least one HI layer comprising Ti₃O₅, preferably the at least two HI and especially all of the HI layers of said mirror coating comprises Ti₃O₅.

The LI layer is also well known and may comprise, without limitation, SiO₂, MgF₂, or a mixture of silica and alumina, especially silica doped with alumina, the latter contributing to increase the reflective coating thermal resistance. The LI layer is preferably a layer comprising at least 80% by weight of silica, more preferably at least 90% by weight of silica, relative to the layer total weight, and even more preferably consists in a silica layer. Optionally, the LI layers may further contain materials with a high refractive index, provided the refractive index of the resulting layer is lower than or equal to 1.55.

When a LI layer comprising a mixture of SiO₂ and Al₂O₃ is used, it preferably comprises from 1 to 10%, more preferably from 1 to 8% and even more preferably from 1 to 5% by weight of Al₂O₃ relative to the SiO₂+Al₂O₃ total weight in such layer.

For example, SiO₂ doped with 4% Al₂O₃ by weight, or less, or SiO₂ doped with 8% Al₂O₃ may be employed. SiO₂/Al₂O₃ mixtures, that are available on the market may be used, such as LIMA® marketed by the Umicore Materials AG company (refractive index n=1.48-1.50 at 550 nm), or L50 marketed by the Merck KGaA company (refractive index n=1.48 at 500 nm).

The mirror coating external layer, i.e., its layer that is the furthest from the substrate is generally a LI layer and typically a silica-based layer, comprising preferably at least 80% by weight of silica, more preferably at least 90% by weight of silica (for example a silica layer doped with alumina), relative to the layer total weight, and even more preferably consists of a silica layer.

Optionally, the mirror coating has at least one LI layer comprising SiO₂, preferably the at least two LI and especially all of the LI layers of said mirror coating comprise SiO₂. For instance, the mirror coating comprises an alternation of LI layer and HI layer, wherein in particular all the LI layers comprise SiO₂ and all the HI layers comprise TiO₃.

Preferably, the mirror coating total thickness is equal to or lower than 800 nm, preferably equal to or lower than 700 nm and in particular equal to or lower than 600 nm.

As used herein, an interval lower than or equal to 800 nm includes the following values and/or any intervals comprised between these values (limits included): 800; 780; 760; 750; 740; 720; 700; 680; 660; 650; 640; 620; 600; 580; 560; 550; 540; 520; 400; 380; 360; 350; 340; 320; 300; 280; 260; etc.

In general, the mirror coating total thickness ranges from 260 nm to 800 nm, preferable from 270 to 700 nm, in particular 300 to 600 nm and typically from 350 to 590 nm.

The inventors have found that the abrasion and/or scratch resistance of the optical article could be improved by having a high proportion of low refractive index layers in the mirror coating as compared to high refractive index layers, in terms of thickness.

Therefore, the HI layers preferably represent less than 20% of the thickness of the reflective coating, more preferably less than 17%. In one embodiment, the HI layers preferably represent 2-40% of the thickness of the mirror coating, more preferably 4-30% or 5-20%, even more preferably 6-17% or 7-15%.

In another embodiment, the LI layers preferably represent 60-98% of the thickness of the mirror coating, more preferably 70-96% or 80-95%, even more preferably 83-94% or 85-93%.

In the same context, the mirror coating does preferably not comprise any HI layer having a thickness higher than or equal to 105 nm, 100 nm, 90 nm, 80 nm, 75 nm, 70 nm or 50 nm. According to this embodiment, each HI layer comprised into the mirror coating according to the invention has a physical thickness ranging from 4 to 50 nm, preferably from 4 to 40 nm, more preferably from 4 to 30 nm, such as 4 to 25 nm.

According to a characteristic of the invention, the total physical thickness of all the HI layers composing said mirror coating that is equal to or lower than 165 nm, preferably equal to or lower than 80 nm and in particular equal to or lower than 70 nm, such as equal to or lower than 60 nm.

According to another characteristic of the invention, the total physical thickness of all the LI layers composing said mirror coating that is ranging from 160 nm to 635, preferably ranging from 190 nm to 600 nm and in particular ranging from 200 nm to 580, such as ranging from 220 to 550 nm.

Generally, each LI layer comprised into the mirror coating according to the invention have a physical thickness ranging from 4 to 300 nm, preferably from 10 to 250 nm, more preferably from 10 to 210 nm, such as 15 to 200 nm.

In general, the ratio of “all the LI layer thicknesses”: “all the HI layer thicknesses” is lower than or equal to 30, preferably lower than or equal to 20, typically ranging from 4 to 20 such as ranging from 4 to 15.

The inventors also discovered new design rules for optimizing the abrasion and/or scratch resistance of the optical article.

When the mirror coating comprises four layers or more (i.e., its number of layers is equal to four), the Applicant found that:
the thickness of the outermost LI layer of the mirror coating should be preferably maximized, while
the thickness of the outermost HI layer of the mirror coating should be advantageously minimized.

Hence, the mirror coating according to the invention has preferably:
an outermost LI layer that has a thickness “Tho” of at least 10 nm, preferably of at least 50 nm, in particular of at least 60 nm, and typically of at least 70 nm, such as at least 80 nm and may be ranging from 50 nm to 120 nm, preferably from 60 to 110 nm, typically from 70 nm to 100 nm;
an outermost HI layer that has a thickness of 75 nm or less, preferably of 50 nm or less, in particular of 40 nm or less, and typically of 30 nm or less, such as 20 nm or less and may be ranging from 4 nm to 30 nm, preferably from 4 to 25 nm, typically from 4 nm to 20 nm.

Generally, this outermost LI layer is the outermost layer of the mirror coating and this outermost HI layer is the penultimate layer among all the layers comprised into the mirror coating.

The Applicant also found that the thickness of the penultimate layer of the mirror coating according to the invention is also a very sensitive parameter, since it appears that it has a much greater influence on the abrasion resistance than the thicknesses of the other layers.

When the mirror coating comprises four layers or more (i.e., its number of layers is equal to four), the Applicant found that:
the thickness “Thp” of the penultimate LI layer of the mirror coating should be preferably maximized, while
the thickness of the penultimate HI layer of the mirror coating should be advantageously minimized.

According to a characteristic of the invention, the mirror coating has a penultimate HI layer that has a thickness ranging from 5 nm to 90 nm, preferably ranging from 5 nm to 70 nm, in particular ranging from 5 nm to 60 nm, typically ranging from 5 nm to 40 nm, such as ranging from 5 nm to 30 nm.

According to another characteristic of the invention, the mirror coating has a penultimate LI layer that has a thickness “Thp” ranging from 50 nm to 300 nm, preferably ranging from 60 nm to 250 nm, in particular ranging from 70 nm to 220 nm, typically of at least 150 nm and ranging for instance from 150 nm to 220 nm.

In a preferred embodiment, Tho/4+Thp ≥180 nm, preferably Tho/4+Thp ≥190 nm, and typically Tho/4+Thp >200 nm. Indeed, the inventors have found that the thickness of the penultimate low refractive index layer had a much greater influence on the abrasion resistance of the optical article than the thickness of the outermost low refractive index layer.

For instance, the mirror coating comprises at least, in the direction moving away from the substrate (from the substrate to the air) the following “general structure”:
L1: one innermost HI layer having a physical thickness of from 4 nm to 50 nm, preferably from 4 nm to 30 nm;
L2: one innermost LI layer having a physical thickness of from 4 nm to 300 nm, preferably from 15 nm to 220 nm;
L3: one HI layer having a physical thickness of from 4 nm to 50 nm, preferably from 4 nm to 30 nm;
L4: one LI layer having a physical thickness of from 10 nm to 250 nm, preferably from 15 nm to 210 nm;
L5: one penultimate HI layer having a physical thickness of from 4 nm to 90 nm, preferably from 5 nm to 70 nm;
L6: one penultimate LI layer having a physical thickness of from 20 nm to 300 nm, preferably from 60 nm to 220 nm;
L7: one outermost HI layer having a physical thickness of from 4 nm to 40 nm, preferably from 4 nm to 30 nm;
L8: one outermost LI layer having a physical thickness of from 50 nm to 120 nm, preferably from 60 nm to 110 nm.

According to an embodiment, the mirror coating comprises at least, in the direction moving away from the substrate (from the substrate to the air) the following “general structure”:
L1: one innermost HI layer having a physical thickness of from 4 nm to 30 nm, preferably from 4 nm to 25 nm;
L2: one innermost LI layer having a physical thickness of from 100 nm to 300 nm, preferably from 140 nm to 225 nm;
L3: one HI layer having a physical thickness of from 4 nm to 40 nm, preferably from 4 nm to 30 nm;
L4: one LI layer having a physical thickness of from 30 nm to 100 nm, preferably from 40 nm to 80 nm
L5: one penultimate HI layer having a physical thickness of from 4 nm to 40 nm, preferably from 4 nm to 20 nm;
L6: one penultimate LI layer having a physical thickness of from 100 nm to 300 nm, preferably from 150 nm to 250 nm;
L7: one outermost HI layer having a physical thickness of from 4 nm to 30 nm, preferably from 4 nm to 25 nm;
L8: one outermost LI layer having a physical thickness of from 50 nm to 120 nm, preferably from 70 nm to 100 nm.
According to another embodiment, the mirror coating comprises at least, in the direction moving away from the substrate (from the substrate to the air) the following “general structure”:
L1: one innermost HI layer having a physical thickness of from 4 nm to 25 nm, preferably from 4 nm to 15 nm;
L2: one innermost LI layer having a physical thickness of from 40 nm to 220 nm, preferably from 50 nm to 200 nm;
L3: one HI layer having a physical thickness of from 4 nm to 35 nm, preferably from 4 nm to 25 nm;
L4: one LI layer having a physical thickness of from 10 nm to 250 nm, preferably from 20 nm to 200 nm
L5: one penultimate HI layer having a physical thickness of from 4 nm to 40 nm, preferably from 4 nm to 25 nm;
L6: one penultimate LI layer having a physical thickness of from 10 nm to 150 nm, preferably from 15 nm to 90 nm;
L7: one outermost HI layer having a physical thickness of from 4 nm to 40 nm, preferably from 4 nm to 30 nm;
L8: one outermost LI layer having a physical thickness of from 50 nm to 120 nm, preferably from 60 nm to 110 nm.

According to another embodiment, the mirror coating comprises at least, in the direction moving away from the substrate (from the substrate to the air) the following “general structure”:
L1: one innermost HI layer having a physical thickness of from 4 nm to 25 nm, preferably from 4 nm to 15 nm;
L2: one innermost LI layer having a physical thickness of from 40 nm to 220 nm, preferably from 50 nm to 200 nm;
L3: one HI layer having a physical thickness of from 4 nm to 25 nm, preferably from 4 nm to 15 nm;
L4: one LI layer having a physical thickness of from 50 nm to 120 nm, preferably from 50 nm to 100 nm;
L5: one HI layer having a physical thickness of from 4 nm to 35 nm, preferably from 4 nm to 20 nm;
L6: one LI layer having a physical thickness of from 150 nm to 250 nm, preferably from 160 nm to 200 nm
L7: one penultimate HI layer having a physical thickness of from 4 nm to 40 nm, preferably from 4 nm to 25 nm;
L8: one penultimate LI layer having a physical thickness of from 10 nm to 100 nm, preferably from 40 nm to 90 nm;
L9: one outermost HI layer having a physical thickness of from 4 nm to 40 nm, preferably from 4 nm to 25 nm;
L10: one outermost LI layer having a physical thickness of from 50 nm to 120 nm, preferably from 60 nm to 110 nm.

The optical article of the invention may be made antistatic that is to say not to retain and/or develop a substantial static charge, by incorporating at least one electrically conductive layer into the stack present on the surface of the article.

The ability for a glass to evacuate a static charge obtained after rubbing with a piece of cloth or using any other procedure to generate a static charge (charge applied by corona . . . ) may be quantified by measuring the time it takes for said charge to dissipate. Thus, antistatic glasses have a discharge time of about a few hundred milliseconds, preferably 500 ms or less, whereas it is of about several tens of seconds for a static glass.

In the present application, discharge times are measured according to the method exposed in the French application FR 2 943 798.

As used herein, an “electrically conductive layer” or an “antistatic layer” is intended to mean a layer which, due to its presence on the surface of a non-antistatic substrate (i.e. having a discharge time higher than 500 ms), enables to have a discharge time of 500 ms or less after a static charge has been applied onto the surface thereof.

The electrically conductive layer may be located on various places in the stack, generally in or in contact with the mirror coating, provided the antireflective properties thereof are not affected. It is preferably located between two layers of the mirror coating, and/or is adjacent to a layer with a high refractive index of such mirror coating. Preferably, the electrically conductive layer is located immediately under a layer with a low refractive index of the mirror coating, most preferably is the penultimate layer of the mirror coating by being located immediately under the silica-based outer layer of the mirror coating: e.g. the “LI outer layer”.

The electrically conductive layer should be thin enough not to alter the transparency of the mirror coating. The electrically conductive layer is preferably made from an electrically conductive and highly transparent material, generally an optionally doped metal oxide. In this case, the thickness thereof preferably varies from 1 to 15 nm, more preferably from 1 to 10 nm. Preferably, the electrically conductive layer comprises an optionally doped metal oxide, selected from indium, tin, zinc oxides and mixtures thereof. Tin-indium oxide (In₂O₃: Sn, tin-doped indium oxide), aluminum-doped zinc oxide (ZnO: AI), indium oxide (In₂O₃) and tin oxide (SnO₂) are preferred. In a most preferred embodiment, the electrically conductive and optically transparent layer is a tin-indium oxide layer, noted ITO layer or a tin oxide layer.

Hence, the present invention provides a mirror coating with an improved conception, comprising a relatively thin stack made of layers, the thicknesses and materials of which have been selected so as to obtain satisfactory mirror performances and a good compromise between very low reflection at the same times in the visible region region and in the approximately UV band ranging especially from 360 nm to 420 nm, while having robustness properties and good cosmetic appearance. In addition, the abrasion resistance properties, such as mechanical crazing properties has been improved, as well as the thermal crazing properties.

Due to the specific design of the mirror coating according to the invention, the optical articles of the invention exhibit preferably a high value of abrasion resistance measured according to the Bayer ASTM (Bayer sand) operating protocol described hereafter, i.e., in accordance with the ASTM F735-81 standard.

According to an embodiment of the present invention, the front face of the optical article is covered by the mirror stack of the invention, exhibits a Bayer value measured in accordance with the ASTM F735-81 standard (sand Bayer value) higher than or equal to 5.5, preferably higher than or equal to any one of the following value: 6, 6.5, 7, 7.5, 8. Thus, the present invention provides optical articles with a high abrasion resistance, since typical sand Bayer values for optical articles are lower than 5, even lower than 3.

Moreover, the optical article according to the invention has a good resistance to heat and temperature variations, i.e., a high critical temperature. In the present patent application, the critical temperature of an article is defined as being the temperature starting from which cracks appear in a coating present at the surface of the substrate (on either main face), which results in degradation of the coating, generally the interferential coating. The critical temperature of an article according to the invention was measured in the manner indicated in patent application WO 2008/001011. It was measured one month after production of the article. The critical temperature of an article coated according to the invention is preferably >60° C., more preferably >70° C., 75° C., 80° C., 85° C. or 100° C.

In one embodiment, the optical article according to the invention does not absorb in the visible or not much, which means, in the context of the present application, that its relative light transmission factor in the visible spectrum Tv is higher than or equal to any one of the following values: 80%, 81%, 82%, 83%, 84%, 85%, 86%, 87%, 88%, 89%, 90%. Said Tv factor preferably ranges from 75% to 90%. In another embodiment, Tv ranges from 85% to 92%.

The Tv factor, also called “luminous transmission” of the system, is such as defined in ISO standard 13666:1998 and is measured accordingly to standard ISO 8980-3. It is defined as the average in the 380-780 nm wavelength range that is weighted according to the sensitivity of the eye at each wavelength of the range and measured under D65 illumination conditions (daylight).

### B.4 Sub-Layer

In one embodiment of the present invention, the mirror coating may be deposited onto a sub-layer. It should be noted that such sub-layer does not belong to the mirror coating.

As used herein, a sub-layer or adhesion layer is intended to mean a relatively thick coating, used in order to improve the mechanical properties such as the abrasion resistance and/or the scratch resistance of said coating and/or so as to reinforce its adhesion to the substrate or to the underlying coating.

Because of its relatively high thickness, the sub-layer does not generally take part to the antireflective optical activity, especially when it has a refractive index close to that of the underlying substrate (which is generally the anti-abrasion and anti-scratch coating or the bare substrate).

The sub-layer should have a thickness that is sufficient for promoting the abrasion resistance of the mirror coating, but preferably not to such an extent that a light absorption could be caused, which, depending on the sub-layer nature, could significantly reduce the relative transmission factor tv. Its thickness is generally lower than 300 nm, more preferably lower than 200 nm, and is generally higher than 90 nm, more preferably higher than 100 nm.

The sub-layer preferably comprises a SiO₂-based layer, this layer comprising preferably at least 80% by weight of silica, more preferably at least 90% by weight of silica, relative to the layer total weight, and even more preferably consists in a silica layer. The thickness of such silica-based layer is generally lower than 300 nm, more preferably lower than 200 nm, and is generally higher than 90 nm, more preferably higher than 100 nm.

In a particular embodiment, the sub-layer consists in a SiO₂ layer.

According to an embodiment, the mirror coating is not deposited onto a sub-layer such as described above.

### B.5 Process

The various layers of the mirror coating and the above-mentioned sublayer are preferably deposited by vapor phase deposition, under vacuum, in a vacuum deposition chamber, according to any of the following methods: i) by evaporation, optionally under ion beam assistance; ii) by ion-beam spraying; iii) by cathode sputtering; iv) by plasma-assisted chemical vapor deposition. These various methods are described in the following references “Thin Film Processes” and “Thin Film Processes II,” Vossen & Kern, Ed., Academic Press, 1978 and 1991, respectively. A particularly recommended method is evaporation under vacuum. Preferably, the deposition of each of the above-mentioned layers is conducted by evaporation under vacuum. Such a process does advantageously avoid heating the substrate, which is particularly interesting for coating heat-sensitive substrates such as organic glasses.

A treatment step with energetic species such as previously defined may also be carried out, simultaneously whilst depositing one or more of the various layers of the reflective coating. In particular, working under ion assistance enables to pack said layers while they are being formed, and increases their compression and refractive index. The use of ion assistance during the deposition of a layer produces a layer that is structurally different from a layer deposited without ion assistance.

The ion assisted deposition method or IAD is notably described in US patent application 2006/017011 and in U.S. Pat. No. 5,268,781. Vapor phase deposition under ion assistance comprises depositing onto a substrate a layer of material by simultaneously bombarding by means of an ion beam said layer while it is being formed, and preferably under ion bombardment achieved by means of an ion gun, where ions are particles composed of gas atoms from which one or more electron(s) is or are extracted. The ion bombardment leads to an atomic rearrangement in the coating being formed, which increases its density. The IAD not only allows an improvement of the deposited layer adhesion, but also an increase in their refractive index. It does preferably consist of bombarding the surface to be treated with oxygen ions. Other ionized gases may be used, either combined with oxygen, or not, for example argon, nitrogen, in particular a mixture of O₂ and argon according to a volume ratio ranging from 2:1 to 1:2.

According to an embodiment of the present invention, the deposition of all the high refractive index layer (i.e.: HI layers) of the mirror coating having a refractive index higher than 1.55 has been carried out under ionic assistance, i.e., those layers have been deposited under the assistance of a source of ions during the formation of those layers.

The outermost low refractive index layer of the mirror coating is preferably deposited without ionic assistance, preferably without concomitant treatment with energetic species. In another embodiment, the low refractive index layers of the mirror coating are deposited without ionic assistance, preferably without concomitant treatment with energetic species.

In one embodiment, no layer of the mirror coating is deposited under ion assistance (preferably no layer of the mirror coating is deposited under concomitant treatment with energetic species), except the electrically conductive layer(s), if present in the mirror coating.

Optionally, the deposition of one or more of said layers is performed by supplying (a supplementary) gas during the deposition step of the layer in a vacuum chamber, such as disclosed in US 2008/206470. Concretely, an additional gas such as a rare gas, for example argon, krypton, xenon, neon; a gas such as oxygen, nitrogen, or mixtures of two gases or more amongst these, is or are introduced into the vacuum deposition chamber while the layer is being deposited. The gas employed during this deposition step is not an ionized gas, more preferably not an activated gas.

This gas supply makes it possible to regulate the pressure and differs from an ionic bombardment treatment, such as ion assistance. It generally enables the limitation of stress in the mirror coating and to reinforce the adhesion of the layers. When such deposition method is used, which is called deposition under gas pressure regulation, it is preferred to work under an oxygen atmosphere (so called “passive oxygen”). The use of an additional gas supply during the deposition of a layer produces a layer that is structurally different from a layer deposited without additional gas supply.

In an embodiment of the invention, the deposition of the sub-layer is performed in a vacuum chamber under a pressure lower than any one of the following values: 1.6×10⁻⁴ mBar, 1.5×10⁻⁴ mBar, 1.4×10⁻⁴ mBar, 1.3×10⁻⁴ mBar, 1.2×10⁻⁴ mBar, 1.1×10⁻⁴ mBar, preferably lower than 10⁻⁴ mBar, more preferably lower than 8.105 mBar and even better lower than any one of the following values 7.10⁻⁵ mBar, 6.10⁻⁵ mBar, 5.10⁻⁵ mBar, 4.10⁻⁵ mBar, 3.10⁻⁵ mBar. Typically, in this preferred embodiment, the pressure is around 1.6×10⁻⁵ mBar.

### B.6 Other Functional Layers

The mirror coating may be deposited directly onto a bare substrate. In some applications, it is preferred that the main surface of the substrate be coated with one or more functional coatings improving its optical and/or mechanical properties, prior to depositing the mirror coating of the invention.

These functional coatings traditionally used in optics may be, without limitation, an impact-resistant primer layer, an abrasion- and/or scratch-resistant coating (hard coat), a hydrophobic and/or oleophobic coating, an antistatic coating especially on the concave face of the optical article, or a stack made of two or more of such coatings.

The mirror coating of the invention is preferably deposited onto an anti-abrasion and/or anti-scratch coating.

The anti-abrasion and/or scratch-resistant coating may be any layer traditionally used as an anti-abrasion and/or anti-scratch coating in the field of ophthalmic lenses. The anti-abrasion and/or scratch-resistant coatings are preferably hard coatings based on poly(meth)acrylates or silanes, generally comprising one or more mineral fillers intended to increase the hardness and/or the refractive index of the coating once cured. Hard anti-abrasion and/or scratch-resistant coatings are preferably prepared from compositions comprising at least one alkoxysilane and/or a hydrolyzate thereof, obtained for example through hydrolysis with a hydrochloric acid solution and optionally condensation and/or curing catalysts.

Suitable coatings, that are recommended for the present invention include coatings based on epoxysilane hydrolyzates such as those described in the patents FR 2 702 486 (EP 0 614 957), U.S. Pat. Nos. 4,211,823 and 5,015,523.

The anti-abrasion and/or scratch-resistant coating composition may be deposited onto the main face of the substrate by dip-or spin-coating. It is then cured by a suitable method (preferably using heat or ultraviolet radiation).

The thickness of the anti-abrasion and/or scratch-resistant coating does generally vary from 2 to 10 μm, preferably from 3 to 5 μm.

Prior to depositing the abrasion-resistant coating and/or the scratch-resistant coating, it is possible to apply onto the substrate a primer coating to improve the impact resistance and/or the adhesion of the subsequent layers in the final product. This coating may be any impact-resistant primer layer traditionally used for articles in a transparent polymer material, such as ophthalmic lenses.

Preferred primer compositions are compositions based on polyurethanes and compositions based on latexes, especially polyurethane type latexes optionally containing polyester units.

Such primer compositions may be deposited onto the article faces by dip-or spin-coating, thereafter be dried at a temperature of at least 70° C. and up to 100° C., preferably of about 90° C., for a time period ranging from 2 minutes to 2 hours, generally of about 15 minutes, to form primer layers having thicknesses, after curing, of from 0.2 to 2.5 μm, preferably of from 0.5 to 1.5 μm.

The ophthalmic lens according to the invention may also comprise coatings formed on the mirror coating and capable of modifying the surface properties thereof, such as hydrophobic and/or oleophobic coatings (antifouling topcoat). These coatings are preferably deposited onto the outer layer of the mirror coating. As a rule, their thickness is lower than or equal to 10 nm, does preferably range from 1 to 10 nm, more preferably from 1 to 5 nm.

Instead of the hydrophobic coating, a hydrophilic coating may be used which provides antifog properties, or an antifog precursor coating which provides antifog properties when associated with a surfactant. Examples of such antifog precursor coatings are described in the patent application WO 2011/080472.

Typically, an optical article according to the invention comprises a substrate that is successively coated on its front face with an impact-resistant primer layer, an anti-abrasion and scratch-resistant layer, an anti-UV, the mirror coating according to the invention and with a hydrophobic and/or oleophobic coating, or with a hydrophilic coating which provides antifog properties, or an antifog precursor coating.

The rear face of the substrate of the optical article may be successively coated with an impact-resistant primer layer, an abrasion-resistant layer and/or a scratch-resistant layer, a traditional antireflective coating, and with a hydrophobic and/or oleophobic coating.

The optical article according to the invention is preferably an ophthalmic lens, such as spectacle lens, or a blank for spectacle lens. The lens may be a solar lens, which may be corrective or not.

### EXAMPLES

### A) General Procedures

The articles employed in the examples comprise a 65 mm-diameter ORMA® lens substrate (obtained through (co)polymerization of the diethyleneglycol bis-allyl-carbonate, refractive index=1.5), with a power of −2.00 diopters and a thickness of 1.2 mm.

The substrate ORMA® comprising the first photochromic compound was supplied by the company Transitions and corresponds to the product XA2 brown. This first photochromatic compound enables to provide a brown tint during the activated state, especially having a hue angle of 25-110. The Examples 1 to 8 below have been performed with this first photochromatic compound.

The substrate ORMA® comprising thesecond photochromic compound was supplied by the company Transitions and corresponds to the product XA2 grey. This second photochromatic compound enables to provide a grey tint during the activated state, especially having a hue angle of 130°-200°. The Examples 9 to 15 below have been performed with this second photochromatic compound.

These photochromatic lenses XA2 were then coated on its convex face (front face) with an impact resistant primer coating based on a W234™ polyurethane material disclosed in the experimental part of WO 2010/109154 (modified to have a refractive index of 1.6 by addition of high refractive index colloids), an abrasion- and scratch-resistant coating (hard coat) that corresponds to the product Mithril@1.6 from ESSILOR, the mirror coating detailed hereafter, and finally the antifouling coating (i.e.: top coat) disclosed in the experimental section of patent application WO 2010/109154, obtained by evaporation under vacuum of the Optool DSX® compound marketed by Daikin Industries (thickness: from 2 to 5 nm).

The various layers were deposited without heating the substrates, by vacuum evaporation, optionally assisted (IAD) during the deposition by a beam of oxygen and possibly argon ions, when specified (evaporation source: electron gun), and optionally under pressure regulation by supplying (passive) O₂ gas into the chamber, where indicated.

The vacuum evaporation device that made it possible to deposit the various reflective layers was a Leybold LAB1100+vacuum coater having two systems for evaporating materials, an electron gun evaporation system and a thermal evaporator (Joule-effect evaporation system), and a Mark II+ion gun (from Veeco Instruments inc.), for use in the preliminary phase of preparation of the surface of the substrate by argon ion bombardment (IPC) and in the ion-assisted deposition (IAD) of the layers.

### B) Preparation of the Optical Articles

The photochromatic lenses were placed on a carrousel provided with circular openings intended to accommodate the lenses to be treated, the convex side facing the evaporation sources and the ion gun.

The method for producing optical articles comprises introducing the lens substrate provided with the primer and abrasion-resistant coatings into a vacuum deposition chamber, conducting a pumping step until a high vacuum was created, followed by an argon ion beam (IPC) with an average pressure of 3.5×10−5 mBar (the ion gun was set to an anode current discharge of 1.8 A, 100 V, 60 seconds, gas flow: 10 sccm of argon), stopping the ionic irradiation, and then successively evaporating the required number of layers (mirror coating layers and antifouling coating) at a rate ranging from 2 to 4 nm/s (0.4 nm/s for the antifouling coating), and lastly a ventilation step. High mirror index layers were obtained by evaporating the substoichiometric titanium oxide (“stabilized Ti₃₀₅”) supplied by Merck.

The deposition conditions of a representative optical article were as follows:
an alternation of a deposition step of the HI layer (Ti₃O₅) under a pressure of 1.210⁻⁴ mBar with O₂ gas for pressure regulation and a deposition step of the LI layer (SiO₂) under a pressure of 2.4×10⁻⁵ mBar without O₂ gas pressure regulation (each HI layer and each LI layer have been deposited by using these conditions),
and lastly a deposition step of an Optool DSX® layer. All the layers were deposited without adding gas in the vacuum chamber during deposition.

### C) Testing Method

The following test procedures were used to evaluate the optical articles prepared according to the present invention. Several samples for each system were prepared for measurements and the reported data were calculated with the average of the different samples.

Colorimetric measurements (in reflection) of the face coated with the exemplified mirror coating (convex/front face): reflection factors Rᵥ or Rm ₍₃₆₀₋₄₂₀₎, hue angle h, a*, b* and chroma C* in the international colorimetric CIE (L*, a*, b*) space were carried out with a Zeiss spectrophotometer, taking into account the standard illuminant D65, and the standard observer 10° (for h and C*). They are provided for an angle of incidence of 15° (see paragraph A) above).

The robustness of the various parameters (i.e.: σh, σC* and σRv) was calculated with the Essential Mac Leod software provided by Thin Film Center (see paragraph A) above).

Abrasion resistance was determined as disclosed in WO 2012/173596. Specifically, abrasion resistance was measured by means of the sand Bayer test, in accordance with the ASTM F735-81 standard, 1 week after production of the article.

The inventors noticed that the Bayer value of the article is decreasing after it has been manufactured. It is preferable to measure the value after stabilization, e.g., at least 1 week after it has been manufactured. In this application, the Bayer values for the examples have been measured 1 week after the articles have been manufactured. The higher the BAYER test value the stronger the abrasion resistance is.

The critical temperature of the article was measured in the manner indicated in patent application WO 2008/001011. It was measured one month after production of the article.

### D) Results

The structural characteristics, optical and mechanical performances of the ophthalmic lenses obtained in the examples are detailed hereunder (“thick” designates thickness”).

TABLE 1
- Brown photochromic lenses -

| No | Material | Ex. 1 | Ex. 2 | Ex. 3 | Ex. 4 | Ex. 5 | Ex. 6 | Ex. 7 | Ex. 8 |
|---|---|---|---|---|---|---|---|---|---|
| | | Substrate + primer/hard coat | | | | | | | |
| L1 | Ti₃O₅ | 6.00 | 6.02 | 6.00 | 6.90 | 6.00 | 8.71 | 6.00 | 6.00 |
| L2 | SiO₂ | 214.91 | 175.89 | 183.91 | 178.25 | 179.61 | 176.40 | 188.58 | 178.90 |
| L3 | Ti₃O₅ | 6.93 | 9.35 | 7.19 | 7.36 | 16.21 | 11.49 | 6.00 | 8.88 |
| L4 | SiO₂ | 63.99 | 177.30 | 180.67 | 190.50 | 53.97 | 176.72 | 191.18 | 167.08 |
| L5 | Ti₃O₅ | 13.24 | 13.55 | 9.88 | 8.91 | 11.29 | 21.63 | 17.10 | 11.79 |
| L6 | SiO₂ | 180.00 | 27.75 | 21.42 | 29.54 | 80.00 | 20.82 | 24.61 | 24.25 |
| Thp | | | | | | | | | |
| L7 | Ti₃O₅ | 19.09 | 15.00 | 10.00 | 10.00 | 13.41 | 24.46 | 23.36 | 15.00 |
| L8 | SiO₂ | 84.07 | 74.80 | 75.56 | 75.53 | 94.29 | 64.01 | 65.84 | 79.44 |
| Tho | | | | | | | | | |

Top coat

Results

| | | | | | | | | |
|---|---|---|---|---|---|---|---|---|
| Total thick | 542.97 | 455.74 | 461.55 | 473.83 | 407.87 | 437.95 | 470.21 | 449.67 |
| SiO₂ (nm) | | | | | | | | |
| Total | 45.26 | 43.92 | 33.07 | 33.16 | 46.91 | 66.29 | 52.46 | 41.67 |
| thickTi₃O₅ | | | | | | | | |
| (nm) | | | | | | | | |
| Total | 588.23 | 499.66 | 494.62 | 506.99 | 454.78 | 504.24 | 522.67 | 491.34 |
| thickness (nm) | | | | | | | | |
| Thickness | 12.00 | 10.38 | 13.96 | 14.29 | 8.70 | 6.61 | 8.96 | 10.79 |
| ratio LI/HI | | | | | | | | |
| HI layers % | 7.7 | 8.8 | 6.7 | 6.5 | 11.5 | 13.2 | 10.0 | 8.5 |
| thickness | | | | | | | | |
| Tho/4 + Thp | 201.02 | 46.45 | 40.31 | 48.42 | 103.57 | 36.82 | 57.53 | 44.11 |
| (nm) | | | | | | | | |
| Rm(360-420) | 0.524 | 0.237 | 0.250 | 0.342 | 0.247 | 0.284 | 0.276 | 0.438 |
| Rv | 6.799 | 3.86 | 4.71 | 3.11 | 7.62 | 5.59 | 3.90 | 4.94 |
| C*(ab) | 42.9 | 34.26 | 34.99 | 28.43 | 49.76 | 37.87 | 23.53 | 43.88 |
| h* (ab) | 96.6 | 30 | 45 | 2 | 79 | 27 | 29 | 55 |
| σRv | 0.59 | 0.51 | 0.54 | 0.35 | 0.55 | 0.69 | 0.35 | 0.61 |
| σC* | 2.51 | 1.69 | 2.59 | 1.54 | 1.96 | 1.93 | 3.57 | 2.67 |
| σh | 3.09 | 6.75 | 6.83 | 6.83 | 2.70 | 7.50 | 7.16 | 4.87 |
| Sand Bayer | — | 4.81 | 6.40 | — | — | — | — | — |
| Critical | — | 60-70 | 60 | — | — | — | — | — |
| temperature + | | | | | | | | |
| 1 Month (° C.) | | | | | | | | |

TABLE 2
- Grey photochromic lenses -

| No | Material | Ex. 9 | Ex. 10 | Ex. 11 | Ex. 12 | Ex. 13 | Ex. 14 | Ex. 15 |
|---|---|---|---|---|---|---|---|---|
| | | Substrate + primer/hard coat | | | | | | |
| L1 | Ti₃O₅ | 18.81 | 6.00 | 6.00 | 6.00 | 7.55 | 8.67 | 7.77 |
| L2 | SiO₂ | 27.49 | 160.43 | 182.92 | 191.89 | 60.08 | 152.80 | 159.98 |
| L3 | Ti₃O₅ | 23.34 | 21.27 | 8.29 | 8.64 | 9.03 | 7.67 | 12.07 |
| L4 | SiO₂ | 50.28 | 32.91 | 60.78 | 81.85 | 60.87 | 24.55 | 27.82 |
| L5 | Ti₃O₅ | 8.05 | 19.76 | 9.27 | 10.19 | 13.87 | 14.21 | 14.72 |
| L6 | SiO₂ | 190.00 | 34.44 | 37.09 | 193.39 | 178.97 | 53.96 | 43.17 |
| L7 | Ti₃O₅ | 9.69 | 10.00 | 10.00 | 16.55 | 11.60 | 11.86 | 13.42 |
| L8 | SiO₂ | 91.24 | 79.25 | 84.41 | 64.96 | 67.31 | 101.00 | 101.74 |
| L9 | Ti₃O₅ | — | — | — | 12.75 | 10.04 | — | — |
| L10 | SiO₂ | — | — | — | 102.76 | 101.64 | — | — |

Top coat

Results

| | | | | | | | |
|---|---|---|---|---|---|---|---|
| Total thick | 359.02 | 227.79 | 280.79 | 532.10 | 367.23 | 231.31 | 230.97 |
| SiO₂ (nm) | | | | | | | |
| Total | 59.90 | 47.03 | 23.56 | 41.38 | 42.05 | 30.55 | 34.57 |
| thickTi₃O₅ (nm) | | | | | | | |
| Total | 418.92 | 274.82 | 304.34 | 573.48 | 409.28 | 261.86 | 265.53 |
| thickness (nm) | | | | | | | |
| Thickness | 5.99 | 4.84 | 11.92 | 12.86 | 8.73 | 7.5 | 6.68 |
| ratio LI/HI | | | | | | | |
| HI layers | 14.3 | 17.1 | 7.7 | 7.2 | 10.3 | 11.7 | 13.0 |
| % thickness | | | | | | | |
| Tho/4 + Thp (nm) | 212.8 | 54.25 | 58.19 | 90.65 | 92.72 | 79.21 | 68.60 |
| Rm(360-420) | 0.764 | 0.703 | 0.395 | 0.149 | 0.380 | 0.362 | 0.726 |
| Rv | 5.248 | 4.95 | 4.98 | 4.80 | 5.60 | 6.48 | 5.67 |
| C*(ab) | 34.8 | 25.96 | 29.07 | 29.00 | 35.56 | 27.38 | 28.92 |
| h* (ab) | 140.2 | 180 | 121 | 190 | 179 | 171 | 150 |
| σRv | 0.36 | 0.30 | 0.21 | 0.30 | 0.37 | 0.32 | 0.25 |
| σC* | 1.68 | 0.42 | 1.68 | 3.67 | 1.22 | 0.49 | 0.85 |
| σh | 6.89 | 6.70 | 6.23 | 12.01 | 8.85 | 9.01 | 7.67 |
| Sand Bayer | — | 4.28 | 6.40 | — | — | — | — |
| Critical | — | 60 | 60 | — | — | — | — |
| temperature + | | | | | | | |
| 1 Month (° C.) | | | | | | | |

As shown by the examples above, the optical articles having a mirror stack according to the invention exhibit both a low reflection in the visible region ranges from 380 nm to 780 nm so as to avoid reflection from the front face of the optical article and a very low reflection at predetermined wavelengths band ranging from 360 to 420 nm corresponding to the activation zone of the at least one photochromatic compound.

In addition, the optical articles having a mirror stack according to the invention exhibit also an excellent optical and color robustness.

Finally, some of the exemplified optical articles that fulfill especially the specific conditions of Tho, thp and Tho/4+Thp have improved abrasion resistance and improved critical temperature. Indeed, some Bayer values obtained are higher than or equal to 6.3, which indicates a very high level of abrasion resistance. It should be noted that a difference of 1-2 points in the Bayer values is highly significant.

1.-15. (canceled)

16. An optical article comprising at least:
(a) a substrate having a front main face and a rear main face;
(b) at least one photochromic compound that is able to undergo a transformation from one state, defined as “deactivated state” to another state, defined as “activated state” in response to a predetermined wavelength band of an electromagnetic spectrum;
(c) coated directly or indirectly onto the front face of said substrate (a), a mirror coating, said mirror coating, comprising:
at least two layers having a low refractive index which is lower than 1.55, defined as “LI layer”, and at least two layers having a high refractive index which is equal to or higher than 1.55, defined as “HI layer”;
and having:
a mean light reflection factor for wavelengths ranging into said predetermined wavelength band of the electromagnetic spectrum, defined as Rm_{(predetermined spectrum)} that is lower than or equal to 1.0%, for an angle of incidence of 15°;
a mean light reflection factor in the visible region Rᵥ that is lower than or equal to 10.0% for an angle of incidence of 15°; and
a standard deviation of said mean light reflection factor in the visible region Rᵥ, defined as “σRᵥ” that is lower than or equal to 0.7% for an angle of incidence of 15°.

17. The optical article according to claim 16, wherein said predetermined wavelength band of the electromagnetic spectrum ranges from 360 nm to 420 nm.

18. The optical article according to claim 16, wherein the mean light reflection factor in the visible region Rᵥ of the mirror coating is higher than or equal to 2.3% for an angle of incidence of 15°.

19. The optical article according to claim 16, wherein the mirror coating has:
a Rm_{(predetermined spectrum)} that is lower than or equal to 0.9% for an angle of incidence of 15°; and
a standard deviation σRᵥ that is lower than or equal to 0.65% for an angle of incidence of 15°.

20. The optical article according to claim 19, wherein the mirror coating has:
the Rm_{(predetermined spectrum)} that is lower than or equal to 0.8% for an angle of incidence of 15°, and
the standard deviation σRᵥ that is lower than or equal 0.60% for an angle of incidence of 15°.

21. The optical article according to claim 16, wherein the mirror coating has a hue angle defined in the international colorimetric CIE L*a*b* (1976) whose standard deviation, defined as “σh”, for an angle of incidence of 15°, is lower than or equal to 13°.

22. The optical article according to claim 21, wherein the mirror coating has the hue standard deviation, σh, for an angle of incidence of 15°, which is lower than or equal to 9°.

23. The optical article according to claim 16, wherein the mirror coating has a Chroma C* defined in the international colorimetric CIE L*a*b* (1976) whose standard deviation, defined as “σC*”, for an angle of incidence of 15°, is lower than or equal to 5.

24. The optical article according to claim 23, wherein the mirror coating has the Chroma standard deviation, σC*, for an angle of incidence of 15°, which is lower than or equal to 4.

25. The optical article according to claim 16, wherein the mirror coating has a Chroma C* defined in the international colorimetric CIE L*a*b* (1976) that is equal to or higher than 20.

26. The optical article according to claim 16, wherein the mirror coating has at least one HI layer comprising Ti₃O₅.

27. The optical article according to claim 16, wherein the mirror coating comprises an alternation of LI layer and HI layer.

28. The optical article according to claim 16, wherein the mirror coating has:
an outermost LI layer that has a thickness Tho of at least 10 nm; and
an outermost HI layer that has a thickness of 75 nm or less.

29. The optical article according to claim 16, wherein the mirror coating has a penultimate HI layer that has a thickness ranging from 5 nm to 90 nm.

30. The optical article according to claim 28, wherein the mirror coating has a penultimate LI layer that has a thickness Thp of at least 150 nm and fulfils the following condition: Tho/4+Thp ≥180 nm.

31. The optical article according to claim 30, wherein the penultimate LI layer of the mirror coating has a thickness Thp of at least 150 nm and fulfils the following condition: Tho/4+Thp ≥190 nm.

32. The optical article according to claim 16, wherein the mirror coating has:
a total physical thickness that is equal to or lower than 800 nm;
a total physical thickness of all the HI layers of said mirror coating that is equal to or lower than 165 nm; and
a total physical thickness of all the LI layers of said mirror coating that is ranging from 160 nm to 635.

33. The optical article according to claim 16, wherein the at least one photochromic compound is:
incorporated directly into the substrate; and/or
incorporated in one coating deposited directly or indirectly at the surface of the substrate,
so as to form a photochromic substrate.

34. The optical article according to claim 33, wherein the residual reflected color of the mirror coating is in correlation with a tint of the photochromic substrate in the activated state.

35. The optical article according to claim 16, wherein the optical article is an ophthalmic lens.

36. The optical article according to claim 35, wherein the ophthalmic lens is a sunglass lens.
